(19) United States
(12) Patent Application Publication
(10) Pub. No.: US 2011/0267158 A1
(43) Pub. Date: Nov. 3, 2011

(54) RELAY WITH INTEGRATED SAFETY WIRING

(76) Inventors: Simon Kalmbach, Altensteig (DE); Karl Steimle, Neubulach (DE); Gunter Kaiser, Jettingen (DE)

(21) Appl. No.: 13/093,257

(22) Filed: Apr. 25, 2011

(30) Foreign Application Priority Data
Apr. 29, 2010 (DE) 10 2010 018 755.0

(51) Int. Cl. H01H 9/02

(52) U.S. Cl. 335/202

(57) ABSTRACT

A relay has a coil housing with a coil arrangement and a movable armature, which by a magnetic flux be generated in the coil arrangement by a coil current, permits or interrupts a flow of current via two main contact terminals; and a control unit in the coil housing for controls the coil current,

### CROSS-REFERENCE TO RELATED APPLICATION

The invention described and claimed hereinbelow is also described in German Patent Application DE 10 2010 018 755.0 filed on Apr. 29, 2010. This German Patent Application, whose subject matter is incorporated here by reference, provides the basis for a claim of priority of invention under 35 U.S.C. 119(a)-(d).

### BACKGROUND OF THE INVENTION

The invention relates to a relay having a coil housing, which housing has a coil arrangement and a movable armature, which armature, by means of the magnetic flux that can be generated in the coil arrangement by means of a coil current, permits or interrupts a flow of current via two main contact terminals.

Relays can be used in the form of monostable or bistable relays in the most various fields of use, such as for controlling utility vehicles, vehicles that travel on rails, construction machines, or floor conveyor machines. For that purpose, until now the relays have had to be acted upon externally, that is, by the customer, with a precisely defined coil signal for controlling the relay. If the coil signal was too weak or too strong, the result was often that the relay was switched incorrectly.

### SUMMARY OF THE INVENTION

By comparison, the object of the invention is to furnish a relay which has high switching safety,

This object is attained according to the invention by a relay of the type defined at the outset, in which a control unit for controlling the coil current is provided in the coil housing.

The control unit, now integrated with the relay, can also, from outside, interpret voltages applied to the relay as a control signal for the relay, if these voltages do not correspond exactly to the voltage required for switching the relay, and can output a precisely defined coil current to the coil of the relay. Field failures from coils subjected to excess current can thus be avoided. Moreover, with the relay of the invention, triggering concepts can be achieved using only low power, such as relay triggering means by means of on-board computers in vehicles, As a rule, on their own, such computers are incapable of furnishing high enough attraction or rejection currents for switching the relay.

In a preferred exemplary embodiment, the control unit can be embodied on an essentially round circuit board. Since as a rule the coil arrangement is round, the circuit board with the control unit can be located in a space-saving way in the coil housing together with the coil arrangement. It is understood that the shape of the circuit board can also be adapted to other geometric shapes of the coil arrangement, such as to a rectangular coil arrangement.

In an especially preferred embodiment of the invention, the circuit board of the control unit can have essentially the same diameter as the coil arrangement. In this way, the coil housing of the relay can be embodied compactly.

A coil bond preferably extends through the circuit board. In that case, the advantage is attained that control electrodes for controlling the relay can be located in a top part of the relay, and at the same the control unit with the circuit board can be located on the coil arrangement.

In a refinement of the invention, cushioned contact pins can be provided for contacting the control unit. The cushioned contact pins offer a reliable electrical connection even when relay vibration is being caused by a vehicle or machine.

The relay is preferably embodied as short-circuit-proof. The relay and in particular the control unit of the relay are thus not damaged even if a short circuit occurs.

It is also preferable that the relay have a mispolarization protector. Damage from incorrect wiring of the relay can be avoided as a result.

The control unit of the relay can be embodied such that coil blowout can be performed by the control unit. As a result of the coil blowout, the control unit can put the relay in a defined switching state.

The relay can have an undervoltage protector. The undervoltage protector can protect the relay against indefinite operating states and can prevent a consumption current circuit from being switched through the relay if the supply voltage is overly low.

By means of the control unit integrated with the relay, the relay can offer a high degree of electronic security and can make virtually powerless switching possible.

In a preferred embodiment of the invention, the relay is embodied as a bistable relay. In the bistable relay, at least one retention means can be provided, in particular a permanent magnet, with which the armature can be fixed in one position. The bistable relay can as a result also be kept in powerless fashion in an ON or OFF position even after the control current has been switched off.

The relay can furthermore have a software-controlled activation and/or deactivation delay, if that is desired by the user. The relay can furthermore be provided with an overvoltage protector.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1, a perspective view, partly in section, of a relay according to the invention; and

FIG. 2, a perspective view of the coil unit and control unit of FIG. 1.

### DESCRIPTION OF THE PREFERRED EMBODIMENTS

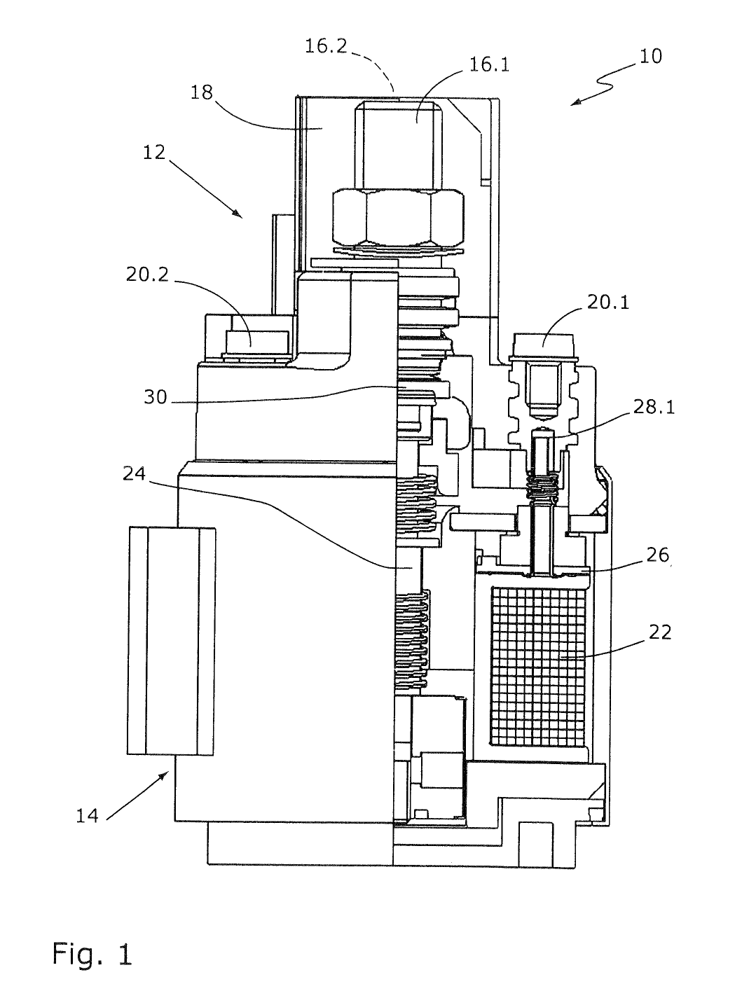

FIG. 1 shows a relay 10 according to the invention, which includes a connection unit 12 and a coil housing 14. The relay 10 is a bistable relay. The connection unit 12 has two main contact terminals 16.1, 16.2. In FIG. 1, a first main contact terminal 16.1 is shown. A second main contact terminal 16.2 is concealed by a breakdown protector 18 in the view in FIG. 1. The connection unit 12 also has three control electrodes, of which two control electrodes 20.1, 20.2 are shown in FIG. 1. A third control electrode is concealed in the rear portion of the relay 10. The coil housing 14 includes a coil arrangement 22, an armature 24, and a control unit 26. The control unit 26 is embodied on an essentially round circuit board, which has the same diameter as the coil arrangement 22. In this way, the control unit 26 can be integrated compactly with the coil housing 14 and is simultaneously shielded by it against interference fields from outside.

For controlling the relay 10, a control signal in the form of a direct voltage is applied to the control electrodes 20.1, 20.2. The control signal is detected by the control unit 26, which is connected electrically by cushioned contact pins 28.1, 28.2, 28.3 to the various control electrodes 20.1, 20.2. The control unit 26 evaluates the control signal and supplies current to the coil arrangement 22. The magnetic flux induced in the coil arrangement 22 moves the armature 24. A main contact bridge 30 is located on the armature 24. By means of the main contact bridge 30, an electrical connection between the main contact terminals 16.1 and 16.2 is opened or closed in accordance with the motion of the armature 24.

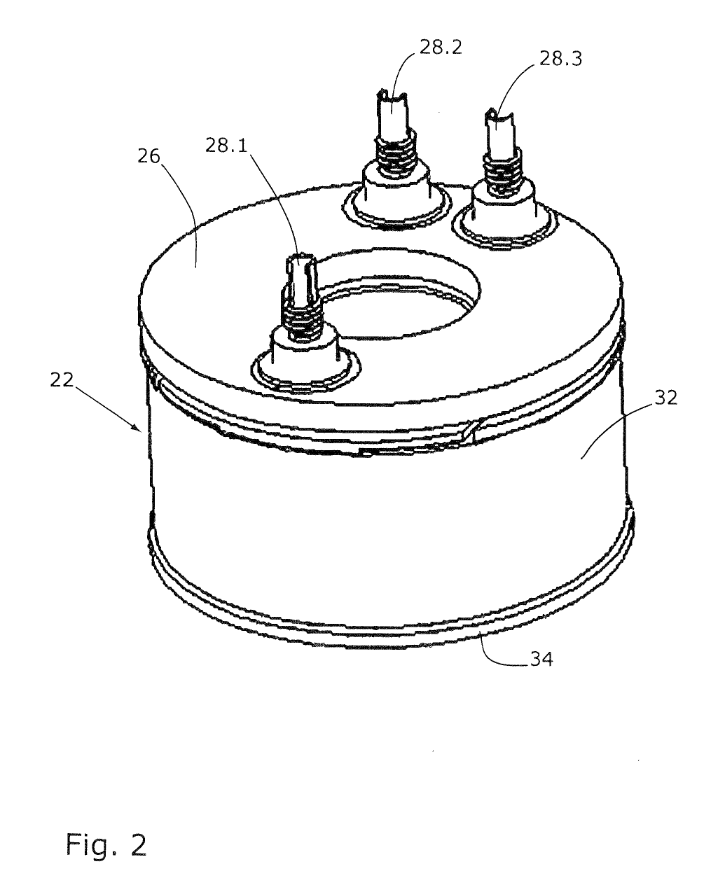

FIG. 2 shows the coil arrangement 22, the control unit 26 embodied on a circuit board, and the cushioned contact pins 28.1, 28.2 and 28.3 of the relay 10 shown in FIG. 1. The relay elements shown in FIG. 2 are all located in the coil housing 14 of the relay 10. The coil arrangement 22 includes a coil 32 and a coil body 34, The control unit 26 is located directly on the coil body 34. The cushioned contact pins 28.1, 28.2, 28.3 are electrically connected to the control electrodes. An electrical connection of the cushioned contact pins 28.1, 28.2, 28.3 is also embodied extending through the control unit 26 to the coil 32.

The wiring of the control unit 26 can preferably be done in three ways:

In a first variant, two cushioned contact pins 28.2, 28.3 are subjected to a supply voltage. The relay 10 is switched on by means of a high level at the cushioned contact pin 28.1 and switched off again by means of a low level at the cushioned contact pin 28.1. The range of the high and low levels can be defined freely within the operating voltage of the relay.

In a second variant, the cushioned contact pin 28.1 is subjected electrically to a negative voltage, The relay is switched on by the application of a positive voltage at the cushioned contact pin 28,2, and it is switched off again by the application of a positive voltage at the cushioned contact pin 28.3.

Finally, in a third variant, the cushioned contact pin 28.3 is subjected continuously to a positive voltage. The relay is then switched on by application of a negative voltage at the cushioned contact pin 28.1 and is switched off by application of a negative voltage at the cushioned contact pin 28.2.

Once the relay has been switched on or off, the control unit 26 reduces the coil current, so that the control unit 26 makes it possible to keep the relay 10 in the applicable switching position in virtually powerless fashion.

The control unit 26 is short-circuit-proof and has a protected coil trigger, a mispolarization protector, and a coil blowout. Moreover, an undervoltage protector, which protects the relay against indefinite operating states, is integrated with the control unit 26.

The control unit 26 can also be triggered by low-power triggering devices, such as on-board computers in vehicles. Locating the control unit 26 in the coil housing 14 makes a compact structure of the relay 10 possible, so that the relay 10 of the invention can replace a conventional relay of the same type. Moreover, the relay with the integrated control unit can be embodied as steam-jet-proof.

It will be understood that each of the elements described above, or two or more together, may also find a useful application in other types of constructions differing from the types described above.

While the invention has been illustrated and described as embodied in a relay with integrated safety wiring, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A relay, comprising a coil housing having a coil arrangement and a movable armature, which by a magnetic flux generated in the coil arrangement by a coil current, permits or interrupts a flow of current via two main contact terminals; and a control unit provided in the coil housing and controlling the coil current.

2. The relay as defined by claim 1, wherein the control unit is embodied on a substantially round circuit board.

3. The relay as defined by claim 2, wherein the circuit board of the control unit has substantially a same diameter as the coil arrangement.

4. The relay as definers in claim 2, further confirming a coil bond extending through the circuit board.

5. The relay as defined by claim 1, further comprising cushioned contact pins making electrical contact with the control unit.

6. The relay as defined by claim 1, wherein the relay is embodied as short-circuit-proof.

7. The relay as defined by claim 6, further comprising a mispolarization protector.

8. The relay as defined by claim 1, wherein the control unit is embodied to perform a coil blowout.

9. The relay as defined by claim 1, further comprising an undervoltage protector.
